(19) United States
(12) Patent Application Publication
(10) Pub. No.: US 2016/0232465 A1
(43) Pub. Date: Aug. 11, 2016

(54) SUBSCRIBER-BASED SYSTEM FOR CUSTOM EVALUATIONS OF BUSINESS RELATIONSHIP RISK

(71) Applicants: Kenneth Kurtz, Lafayette, CA (US); Todd Lane, Ballwin, MO (US)

(72) Inventors: Kenneth Kurtz, Lafayette, CA (US); Todd Lane, Ballwin, MO (US)

(21) Appl. No.: 13/153,363

(22) Filed: Jun. 3, 2011

(51) Int. Cl. G06Q 10/06

(52) U.S. Cl. CPC G06Q 10/0635; G06Q 10/067

(57) ABSTRACT

A server generates a risk tier map based on risk inventory data for a subscriber. The risk tier map comprises a plurality of risk tiers. The server generates a custom risk model for the subscriber based on a plurality of risk factors. The plurality of risk factors can be configured based on subscriber data. The server executes the custom risk model to determine a risk score for one or more entities and determines a risk recommendation for the one or more entities using the entity risk score and the risk tier map.

### RELATED APPLICATION

The present application is related to co-filed U.S. patent application Ser. No. ______ entitled “Customizable Compliance System” (attorney docket number 09123.5 (P004)), which is assigned to the assignee of the present application.

### TECHNICAL FIELD

Embodiments of the present invention relate to a risk analyzer. Specifically, the embodiments of the present invention relate to providing a custom risk analysis service.

### BACKGROUND

Many multinational corporations operate in a decentralized environment. Corporations have anywhere from a few dozen to many thousands of overseas relationships with third parties. The third parties may include resellers, distributors, channel partners, manufacturers, vendors, licensing representatives, sales and marketing consultants, export agents, joint venture partners, and acquisition targets, etc. They operate in different regions around the world and are often engaged by the sales or marketing divisions of decentralized business units having little contact with the headquarters legal and compliance departments. Many regulations governing foreign business relationships, such as the U.S. Foreign Corrupt Practices Act (FCPA), are making investigation and prosecution of bribery and corruption a top priority. The increased enforcement activity has stirred even the most risk tolerant multinational companies to assess how they evaluate all of their relationships overseas. The lack of due diligence of a company's agents, vendors, and suppliers, as well as merger and acquisition partners in foreign countries could lead to a company engaging in business with an organization linked to foreign officials or state owned enterprises. Such links could be perceived as leading to the bribing of the foreign officials, which may lead to a company's noncompliance with the FCPA.

Due diligence in regard to FCPA compliance is required in two aspects: (1) initial due diligence and (2) ongoing due diligence. Initial due diligence includes evaluating what risk is involved in a company engaging in a relationship with a third party prior to the company establishing the relationship with the third party. Ongoing due diligence includes periodically evaluating each relationship overseas to find links between current business relationships overseas and ties to a foreign official or illicit activities linked to corruption. Ongoing due diligence can be performed indefinitely as long as a relationship exists.

Some companies utilize a procurement tool that implements a process for evaluating potential vendors and new customers. Such procurement tools are generally procurement focused and accounting related and do not determine what risks are involved in conducting business with the vendor. Some conventional risk analysis solutions may be automated, but typically take a forensic approach to risk modeling by taking a snapshot of a relationship between a company and a third party as their relationship exists today. Conventional solutions do not project risk prior to a company conducting business transactions with a third party. Such risk analysis systems rely on a company to already enter into a business relationship with a third party, perform transactions with the third party, and subsequently use the historical transactional data, such as accounting data, to determine the risk of conducting business with the third party. For example, conventional solutions look at financial transactions between a company and a third party to identify abnormalities that could be bribery, at which point it may be too late because a company is already engaging in business with the third party.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is an exemplary network architecture in which embodiments of the present invention may operate.

FIG. 2 is a block diagram of one embodiment of a risk analyzer.

FIG. 3 is an exemplary graphical user interface for a subscriber.

FIG. 4 is a flow diagram of an embodiment of a method for generating a risk tier map.

FIG. 5 is a flow diagram of an embodiment of a method for generating a custom risk model for a subscriber.

FIG. 6 is a flow diagram of an embodiment of a method for analyzing risk of one or more entities.

FIG. 7 is a diagram of one embodiment of a computer system for providing a custom risk analysis service.

### DETAILED DESCRIPTION

Embodiments of the invention are directed to a method and system providing a custom risk analyzer. A server generates a risk tier map based on risk inventory data for a subscriber. The risk tier map comprises a plurality of risk tiers. The server generates a custom risk model for the subscriber based on a plurality of risk factors. The plurality of risk factors can be configured based on subscriber data. The server executes the custom risk model to determine a risk score for one or more entities and determines a risk recommendation for the one or more entities using the entity risk score and the risk tier map.

Conventional risk analyzers involve a labor intensive and inefficient process for determining the risk of conducting business with one or more entities. Traditional risk analyzers include a manual process prone to human errors and inconsistencies in decision making even when the decision factors are the same. In addition, conventional risk analysis solutions rely on transactional data, such as accounting data and other financial transactions between a company and a third party, to determine the risk of the company conducting business transactions with the third party, at which point it may be too late because a company is already engaging in business with the third party. Embodiments of the present invention provide an automated, configurable, and scalable solution to define a custom risk model, to consistently execute the custom risk model, to determine the risk of an entity, and to determine the risk prior to and while a subscriber engaging in a business transaction with an entity.

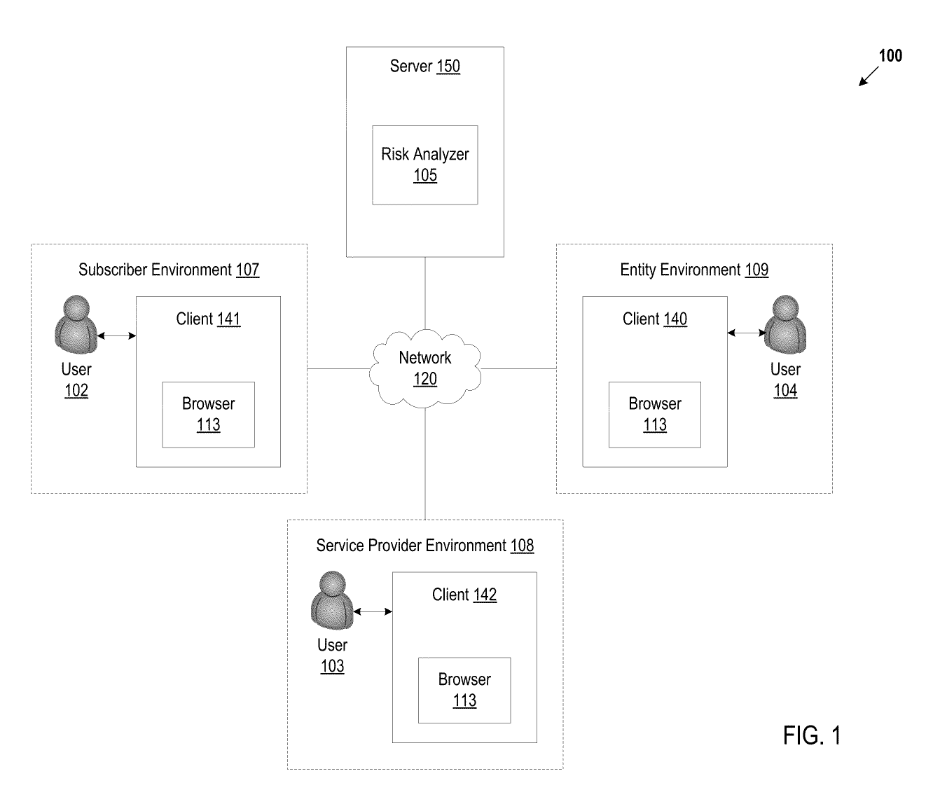

FIG. 1 is an exemplary network architecture 100 in which embodiments of the present invention can be implemented. The network architecture 100 can include a server 150, one or more clients 141 in one or more subscriber environments 107, one or more clients 140 in one or more entity environments 109, and one or more clients 142 in one or more service provider environments 108 communicating via a network 120. The network 120 can be a local area network (LAN), such as an intranet within a company, a wireless network, a mobile communications network, a wide area network (WAN), such as the Internet, or similar communication system. The network 120 can include any number of networking and computing devices such as wired and wireless devices.

A server 150 can host a risk analyzer 105 to provide a risk analysis service to subscribers that subscribe to the service. A subscriber can be a multinational company that is operating in a decentralized environment, such as operating with entities in various countries to conduct the company's business. A subscriber can subscribe to the risk analysis service provided by the risk analyzer 105 to determine a level of risk for conducting business with an entity. Examples of risk levels can include, and are not limited to, low risk, medium risk, and high risk. The risk analyzer 105 can provide an automated, configurable, and scalable solution to define a custom risk model and to execute the risk model to determine the risk of a large number of entities.

The risk analyzer 105 can provide user interfaces, such as graphical user interfaces (GUIs), to receive subscriber user input and to automatically create and display a risk tier map for the subscriber based on the input. The risk tier map comprises a plurality of risk tiers, which can be associated with a scope of due diligence to be conducted on an entity and a risk score. A subscriber can provide user input defining the number of tiers and the parameters for each tier. A risk tier can also be associated with a scope of training and education or other actions, such as approvals to contract or audit frequencies required for an entity. The risk analyzer 105 can automatically create a custom risk model for the subscriber based on the input, test the risk model, publish the risk model, and execute a published risk model to determine a risk score for each entity.

The risk analyzer 105 can automatically make a risk recommendation for each entity using the risk scores of the entities and the risk tier map. The risk recommendation can be made prior to a subscriber engaging in any business transactions with an entity that is being evaluated. A subscriber may have a business relationship with an entity and may or may not be conducting business transactions while in the business relationship. The risk recommendation can also be made for a subscriber that is conducting business transactions with an entity and the risk recommendation is made without using historical business transactional data.

A risk recommendation can include a recommended due diligence investigation to be performed on an entity, a recommended training for the entity, approvals to be obtained for a subscriber to conduct a business transaction with an entity, legal documents to be executed, audit frequencies, etc. A risk recommendation can also include a recommendation that no further action needs to be performed. A risk recommendation can also include a recommendation for an internal subscriber action to be performed. For example, if a third party is identified as a low risk, the risk recommendation may not recommend a due diligence investigation to be performed or may possibly recommend that a due diligence investigation be performed internally by a subscriber.

The risk analyzer 105 can also use the entity risk scores and the risk tier map to determine one or more compliance factors that an entity should satisfy. In one embodiment, the risk analyzer 105 is coupled to a compliance system and the risk analyzer can provide the compliance system with data to configure which compliance factors to be completed based on a level of risk that is associated with an entity. For example, low risk entities may have different compliance factors or less compliance factors than high risk entities.

In one embodiment, the server 105 hosts a third party management system that includes a risk analyzer 105 as a sub-system. In another embodiment, the server hosts a compliance management system that includes a risk analyzer 105 as a sub-system. The risk analyzer 105 can be implemented as a SaaS (software as a service) solution where subscribers, entities and service providers do not need to install software, but can access the risk analyzer 105 using an Internet connection. In other embodiments, the risk analyzer 105 is part of the subscriber environment 107 or a service provider environment 108.

A service provider (e.g., a due diligence investigation service provider, a training and education service provider, etc.) can conduct a recommended service (e.g., recommended due diligence investigation, recommended training, auditing, etc.) for a particular entity. The risk analyzer 200 can communicate with a client 142 in a service provider environment 108 to cause a service provider to perform a service based on the risk recommendation. The risk analyzer 200 can also communicate with a client 141 in a subscriber environment 107 to cause a subscriber to perform a service based on a risk recommendation.

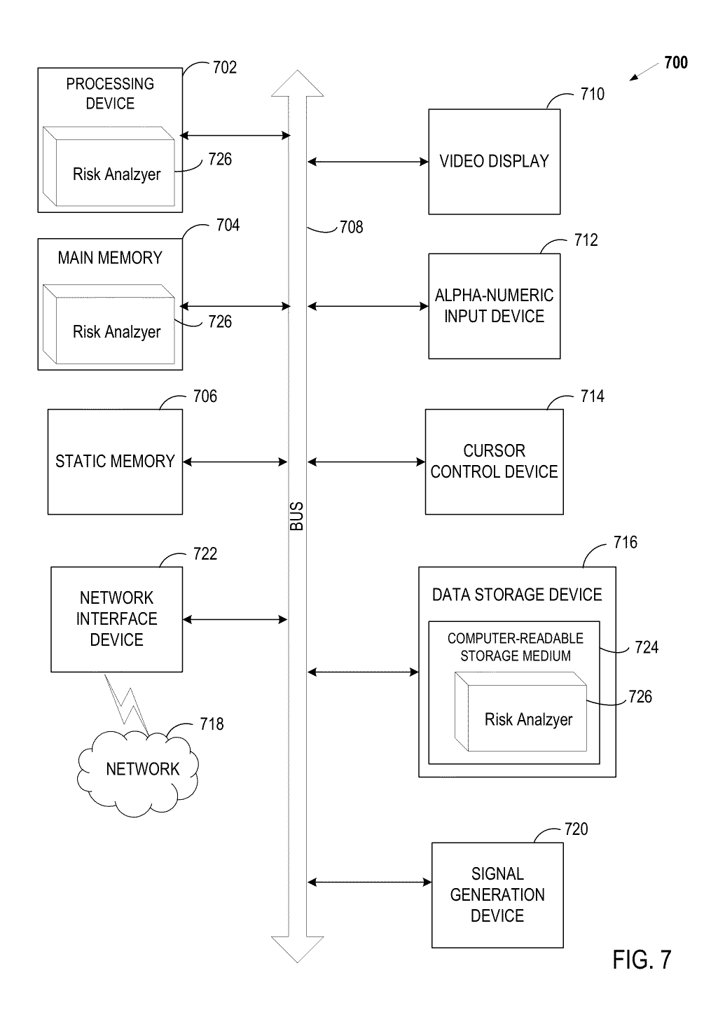

A user 102-104 can use a browser 113, or similar type of application, hosted by a client 140-142, to access the risk analysis service provided by the risk analyzer 105. A server 150 can be hosted by any type of computing device including server computers, gateway computers, desktop computers, laptop computers, hand-held computers or similar computing device. The client machines 140-142 can be hosted by any type of computing device including server computers, gateway computers, desktop computers, laptop computers, mobile communications devices, cell phones, smart phones, hand-held computers, or similar computing device. An exemplary computing device is described in greater detail below in conjunction with FIG. 7.

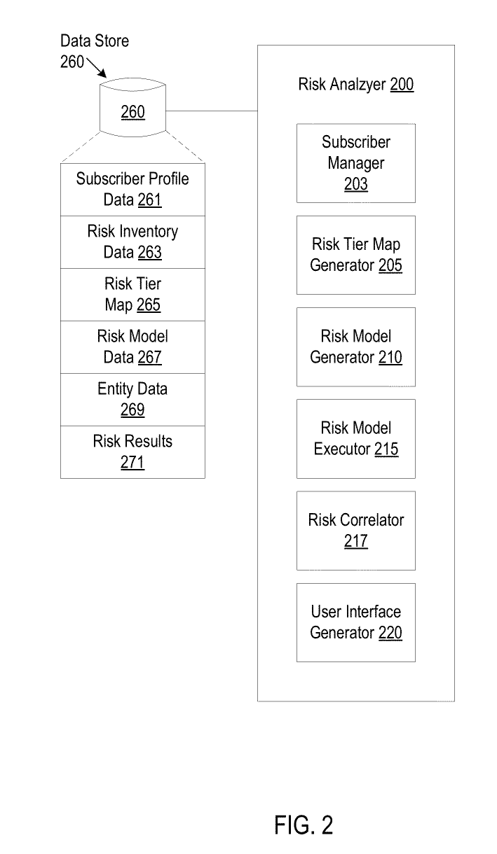

FIG. 2 is a block diagram of one embodiment of a risk analyzer 200 for providing a custom risk analysis service. The risk analyzer 200 can be the same as the risk analyzer 105 hosted by the server 150 of FIG. 1. The risk analyzer 200 includes a subscriber manager 203, a risk tier map generator 205, a risk model generator 210, a risk model executor 215, a risk correlator 217, and a user interface generator 220. More or less components can be included in system 200 without loss of generality.

The subscriber manager 203 can create a profile for a subscriber based on subscriber data. The subscriber data can be received as input, for example, as user input via a user interface. A user, such as a subscriber system administrator, can provide the data to create the profile. The user interface generator 220 can provide a user interface to receive user input. The user interface can be a graphical user interface (GUI). Examples of subscriber data can include, and are not limited to, data pertaining to a company, data pertaining to employees of a company, data defining user roles for different levels of subscriber access, data defining the one or more types of entities a subscriber would like to evaluate, data defining one or more subtypes of an entity, terminology relative to a subscriber's business, user interface preferences (e.g., fonts, icons, menu items, drop down lists, buttons, etc), etc. The subscriber data can be stored as subscriber profile data 261 in a data store 260 that is coupled to the risk analyzer 200. A data store 260 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

For example, a subscriber can provide subscriber profile data 261 to define various entity types, such as an intermediary, a client, a vendor, etc., and one or more sub-types, such as sub-types of an intermediary as a distributor, a consultant, an agent, etc. In another example, subscriber profile data 261 can define an administrator role with unlimited access to the compliance service, a manager role that limits access to the compliance service to a region or a department being managed, and a user role that limits access to the compliance service for a particular user. The user interface generator 220 can generate and provide a subscriber user interface based on the subscriber profile data 261. The subscriber user interface can be accessed, for example, by a web browser on a client.

The data store 260 can store risk inventory data 263 for one or more subscribers. The risk inventory data 263 can be user-defined. A subscriber can conduct a risk inventory, for example, using the services of a risk consultant, to determine the different levels of risks to use to categorize the entities which a subscriber wishes to evaluate. A subscriber can provide the risk inventory data to the risk analyzer 200. The risk inventory data 263 can include risk scores, scope of due diligence, risk tier names, etc.

The risk tier map generator 205 can create a risk tier map based on the risk inventory data 263 and store the risk tier map 265 in the data store 260. A risk tier map can define one or more risk tiers, the risk scores that correspond to each tier, the scope of action that corresponds to each tier, such as a scope of due diligence and/or a level of training, approvals to be obtained for a subscriber to conduct a business transaction with an entity, etc. A subscriber's corporate office can subscribe to the risk analysis service to define the risk tiers at a corporate level and can use the risk analysis service to implement the risk tiers at the enterprise level.

A risk tier map can have any number of tiers. Table 1 below illustrates an exemplary risk tier map having four tiers.

TABLE 1

| Risk Score Range | Scope of Due Diligence | (Risk) Tier |
|---|---|---|
| 70-100 | Enhanced Due Diligence | High |
| 50-69 | Open Source Investigation | Medium |
| 30-49 | Global Database Check | Low |
| 0-29 | Internal Investigation | Default |

The user interface generator 220 can provide a GUI that includes a risk tier map for a subscriber. The GUI can be a user interface to receive the subscriber input of the tier names, the description for each type of scope of action, and a risk score range for each tier. In one embodiment, a risk tier map is created with a tier that includes a default risk score. The default risk score can be created based on input, such as subscriber user input received via a GUI. The risk tier map generator 205 can also receive subscriber user input to override the created default risk scores.

Table 2 below illustrates an exemplary risk tier map having nine tiers. A scope of action, such as a scope of due diligence may not change amongst some of the tiers. The risk analyzer 200 can be configured via subscriber user input to use the different tiers to trigger internal subscriber processes. For example, an entity that receives a score in the range of 90-100 may be required to obtain Director level subscriber approval before a subscriber can conduct business with the entity.

TABLE 2

| Risk Score Range | Scope of Due Diligence | (Risk) Tier |
|---|---|---|
| 90-100 | Enhanced Due Diligence | High |
| 80-89 | Enhanced Due Diligence | High |
| 70-79 | Enhanced Due Diligence | High |
| 60-69 | Open Source Investigation | Medium |
| 50-59 | Open Source Investigation | Medium |
| 40-49 | Open Source Investigation | Medium |
| 30-39 | Global Database Check | Low |
| 20-29 | Global Database Check | Low |
| 10-19 | Global Database Check | Low |
| 0-9 | Internal Investigation | Default |

The risk model generator 210 can create a customer risk model for a subscriber, which when executed, can determine risk scores for a number of entities which the subscriber wishes to evaluate for risk. The risk model generator 210 can create a new risk model and update an existing risk model, for example by cloning an existing risk model and modifying the clone. The risk model generator 210 can associate a risk model with one or more particular entity types and/or entity sub-types, for example, based on subscriber input. For instance, the risk model generator 210 can create a new risk model for all sub-types (e.g., distributor, agent, consultant, etc.) of an entity type ‘intermediary’. In another example, the risk model generator 210 can create a risk model that applies only to the sub-type ‘distributor’ of an entity type ‘intermediary’.

The risk model generator 210 can define risk factors to be used in a risk model to calculate a risk score for an entity. The risk factors can include subscriber specified risk factors, such as a Due Diligence Questionnaire (DDQ), and a Business Justification Questionnaire, whether the third party is publicly listed with a defined market capitalization, the annual volume of business or number of transactions projected for a prospective third party, or the annual volume of business or number of transactions conducted with an existing thirty party. In one embodiment, the risk factors are not based on historical business transaction data, such as accounting data or other similar financial data, between a subscriber and a third party and can be based on projected data.

In one embodiment, the risk model generator 210 uses at least one of the following risk factors in the risk model to calculate risk of entity: (1) the third party category, such as the entity type and/or entity sub-type as specified by a subscriber, (2) an annual index, such as the Corruption Perception Index (CPI) published annually by Transparency International, (3) data from a questionnaire, such as a Due Diligence Questionnaire, and (4) data from a Business Justification Questionnaire. The data published by the CPI can be stored in the data store 260 and integrated into the risk analyzer 200. The entity type and/or entity sub-type, Due Diligence Questionnaire, and Business Justification Questionnaire can be defined by a subscriber, stored in the data store 260, and integrated into the risk analyzer 200. Examples of business justification data can include, and are not limited to the types of contracts an entity may engage with a subscriber, a volume of business that an entity may conduct with a subscriber, etc. In another embodiment, additional risk factors can be used to calculate the risk of an entity.

A subscriber can provide multiple versions of risk factor data (e.g., questionnaires, index data, etc.) to be used in evaluating the risk of an entity. The risk model generator 210 can select a version to be used based, for example, on subscriber input, default settings to use the most recent version, etc.

The risk model generator 210 can configure weights for the risk factors based on subscriber input data. The user interface generator 220 can provide a GUI to receive the subscriber input of the weight to assign to each risk factor. A weight can be a value that can indicate the importance of a risk factor. A weight can represent a percentage of a total risk score. When an entity is evaluated the risk analyzer 200 can generate a risk score for the entity. The risk score can be represented as a number. The risk score may be adjusted based on weights that are assigned to each risk factor. Table 3 below illustrates an exemplary weighting of risk factors based on subscriber input. In this example, the risk model generator 210 assigns the greatest weights to the ‘Corruption Perception Index (CPI)’ and ‘Due Diligence Questionnaire’ risk factors based on subscriber input indicating that they are more important than the other risk factors. The input can specify a weight value for a particular risk factor. The configured weights can be stored as part of the risk model data 267.

TABLE 3

| Enabled Risk Factor | Weight (percentage of Total Score) |
|---|---|
| Third Party Category | 10 |
| Corruption Perception Index (CPI) | 50 |
| Due Diligence Questionnaire Data | 25 |
| Business Justification Data | 15 |

The risk model generator 210 can configure the scoring for each risk factor, for example, based on subscriber user input. The user interface generator 220 can provide a GUI to receive the subscriber input of the score to assign to each entity type and/or entity sub-type. The configured risk factor scores can be stored as part of the risk model data 267. The input can specify how to score a particular risk factor. For example, Table 4 below illustrates an exemplary scoring of the Third Party Category risk factor for an entity type ‘intermediary’ having entity sub-types ‘Agent’, ‘Distributor’, ‘Reseller’, ‘Other’ and ‘Test’ as defined by subscriber input.

TABLE 4

| Score | Third Party Category |
|---|---|
| 10 | Agent |
| 7 | Distributor |
| 5 | Distributor and Reseller |
| 3 | Other |
| 0 | Test |

In this example, risk model generator 210 configured the Third Party Category risk factor comprising 10% of the total risk score for an entity, as seen in Table 3. The risk model generator 210 can assign a score between 0-10% to each entity sub-type as illustrated in Table 4.

Table 5 below illustrates an exemplary scoring of the Corruption Perception Index (CPI) risk factor as defined by subscriber input. The user interface generator 220 can provide a GUI to receive the subscriber input of how to score the data from the Corruption Perception Index. The Corruption Perception Index defines a low score as high risk. The Corruption Perception Index assigns various countries a CPI value, such as a value between 0-7. In one embodiment, the risk model generator 210 can override the risk score associated with a given CPI value, for example, based on subscriber input. The user interface generator 220 can provide a GUI to receive the subscriber input of a new CPI value for a country. For example, the CPI may assign a country a low score of 3.3 because the CPI deems the country is a high corruption risk country. A subscriber may be headquartered in the particular country and may not consider the country high risk. The risk model generator 210 can change the risk score associated with the default CPI value of 3.3 from 35 to 25, for example, based on subscriber input. The risk model generator 210 can assign a CPI value or a risk score to countries which do not have a CPI value based on, for example, default settings in the risk analyzer 200 and/or subscriber input.

The risk model generator 210 can create tiers based on the CPI value range and the subscriber input. In this example, risk model generator 210 configured the CPI risk factor comprising 50% of the total risk score for an entity, as seen in Table 3. The risk model generator 210 can configure a range of a CPI value, such as 0.0≦3.0 to correspond to a score of 50 based on the subscriber input. The risk model generator 210 can associate the number of countries with each score. For example, there are 31 countries within the range ≧3.0≦3.8 that correspond to a score of 35.

TABLE 5

| Score | CPI Value Range | Countries |
|---|---|---|
| 0 | ≧7.0 | 23 |
| 10 | ≧5.0 ≦ 7.0 | 28 |
| 25 | ≧3.8 ≦ 5.0 | 23 |
| 35 | ≧3.0 ≦ 3.8 | 31 |
| 50 | 0.0 ≦ 3.0 | 75 |

The risk model generator 210 can configure the score of the Due Diligence Questionnaire risk factor. Table 6 below illustrates an exemplary scoring of the Due Diligence Questionnaire risk factor as defined by subscriber input. The user interface generator 220 can provide a GUI to receive the subscriber input of how to score the data from the DDQ. In this example, risk model generator 210 configured the DDQ risk factor comprising 25% of the total risk score for an entity, as seen in Table 3. The risk model generator 210 can configure the score of the DDQ risk factor as 75% of its weighted value when an entity has not submitted a DDQ. For instance, the weight of the DDQ is 25 and the entity receives 18.75 if it has not submitted the questionnaire.

TABLE 6

| Score | Due Diligence Data |
|---|---|
| 75% | Default Score |

In one embodiment, risk model generator 210 can configure selected questions in a questionnaire to comprise the score given to an entity for the DDQ risk factor based on subscriber input. For example, the risk model generator 210 configured the DDQ risk factor comprising 25% of the total risk score for an entity, as seen in Table 3. The DDQ may contain 100 questions. The subscriber input can associate a score with selected questions. Table 7 below illustrates an exemplary scoring of the Due Diligence Questionnaire data based on selected questions.

TABLE 7

| Score | Due Diligence Data |
|---|---|
| 5 | Question No. 05 |
| 5 | Question No. 06 |
| 5 | Question No. 10 |
| 5 | Question No. 55 |
| 5 | Question No. 99 |

Selected questions can include questions in a questionnaire that are configured without open text fields, such as questions configured with selectable answers (e.g., multiple choice questions, yes/no questions, etc.), pre-defined values, etc.

In one embodiment, the risk analyzer 200 is coupled to a compliance system. A subscriber can have an internal compliance policy that defines what operations an entity should satisfy in order to adhere to the subscriber's compliance policy, such that a subscriber can determine whether to conduct or continue to conduct business transactions with the entity. A compliance system can provide an assessment of an entity's compliance status. An internal person at a subscriber can complete a Business Justification Questionnaire to help a subscriber identify which compliance steps of the due diligence process third parties should satisfy, such as, complete a questionnaire, execute an anti-corruption declaration. Business Justification Questionnaires are internal to a subscriber and may be required by a subscriber enterprise business unit to justify doing business with an entity. An internal person at the subscriber can describe why a subscriber company should conduct business with a particular entity. For example, based upon a response to the Business Justification Questionnaire, no further due diligence compliance steps may be required to approve doing business with a third party. For example, data from a Business Justification Questionnaire may indicate that a public company has a $3 billion market capitalization, and the risk analyzer 200 may generate a risk score that corresponds to “low risk” for this public company based on the Business Justification Questionnaire data. A risk score that corresponds to “low risk” may be an indication that no further due diligence steps are required.

The risk model generator 210 can configure the risk score of the business justification risk factor. Table 8 below illustrates an exemplary risk scoring of the Business Justification Questionnaire risk factor as defined by subscriber input.

TABLE 8

| Score | Business Justification Data |
|---|---|
| 75% | Default Score |

The user interface generator 220 can provide a GUI to receive the subscriber input of how to score the data from the business justification data. In this example, risk model generator 210 configured the business justification risk factor comprising 15% of the total risk score for an entity, as seen in Table 3. The risk model generator 210 can configure the risk score of the business justification risk factor as 75% of its weighted value when a business unit within the enterprise has not submitted a Business Justification Questionnaire. For instance, the weight of the Business Justification Questionnaire is 15 and the entity receives 11.25 if the business unit of the subscriber enterprise has not submitted the questionnaire. In one embodiment, risk model generator 210 can configure selected questions in a questionnaire to comprise the score given to an entity for the business justification risk factor based on subscriber input. The configured risk model for a subscriber, which includes the configured weights and scores for the risk factor, can be stored in the data store 260 as risk model data 267.

In one embodiment, the risk analyzer 200 can receive input, such as subscriber user input, to identify entities or subscriber enterprise business units to receive an invitation to complete one or more questionnaires (e.g., DDQ, Business Justification Questionnaire). The input can identify the entity or business unit to send the invitation to, the entity or business unit contact information, the entity type and/or entity sub-type, etc. In one embodiment, the risk analyzer 200 triggers another system (e.g., third party management system, compliance system) to send an invitation to an entity and subscriber business unit. In another embodiment, a subscriber can directly send an invitation to an entity to complete one or more questionnaires. In another embodiment, the requirement for an invitation can be triggered by a workflow of another system (e.g., a compliance system, a third party management system) that is coupled to the risk analyzer 200. The risk analyzer 200 can receive entity data from entities that are responding to an invitation and can store the entity data 269 in the data store 260. The entity data 269 can include, and is not limited to, questionnaire answers, entity information, etc.

The risk model executor 215 can execute the configured risk model for a subscriber to test the risk model against entity data 269 for one or more entities that is stored in the data store and generate risk results 271. The risk model executor 215 can execute a risk model based on, for example, user input. The user interface generator 220 can provide a GUI to receive the subscriber input to execute a risk model. The input can specify to test a risk model, to publish a test model, to execute a published test model, etc. Table 9 below illustrates exemplary risk results 271 from testing a risk model that is associated with all sub-types (e.g., distributor, agent, consultant, etc.) of an entity type ‘intermediary’.

TABLE 9

| Risk Tier | Entities |
|---|---|
| High | 561 |
| Medium | 3439 |
| Low | 5330 |
| Default | 2 |

The risk results 271 can include the risk tiers, the number of entities that correspond to the risk tiers, a risk score for each entity, etc. The user interface generator 220 can provide a GUI that includes the risk results 271. The risk results 271 can be stored in the data store 260. The risk results 271 can include test results and actual results from executing a published risk model. The risk results 271 can include audit data pertaining to the execution of a published risk model. The audit data can include, the date and time a risk model is published, the data and time for each execution of a published risk model, etc.

When a published risk model is executed by the risk model executor 215, the risk model executor 215 assigns a risk score to each entity as determined by the risk model. The risk correlator 217 can correlate a risk score of an entity to the risk tier map 265 that is stored in the data store 260 and provide a risk recommendation based on the correlation. For example, a subscriber ‘XYZ Company’ subscribes to the risk analysis service provided by the risk analyzer 200. The risk model executor 215 executes a published risk model for the XYZ Company to evaluate a number of entities, including entity ‘ACME Company’. ACME Company is assigned a risk score and the risk correlator 217 correlates ACME Company's risk score to the risk tier map 265 for XYZ Company and determines that ACME Company is a high risk entity. The risk correlator 217 generates a recommended scope of due diligence of ‘Enhanced Due Diligence’ for ACME Company based on the risk tier map 265. The correlation and recommendation for an entity can be stored as risk results 271 in the data store. The user interface generator 220 can provide a GUI that includes the correlation and recommendation of an entity.

A service provider, such as one that provides due diligence investigation services, can conduct an Enhanced Due Diligence investigation on entity ACME Company based on the recommendation of the risk correlator 217. The risk analyzer 200 can communicate with a client in a service provider environment (e.g., client 142 service provider in service provider environment 108 in FIG. 1) to coordinate a service (e.g., Enhanced Due Diligence investigation) based on the recommendation.

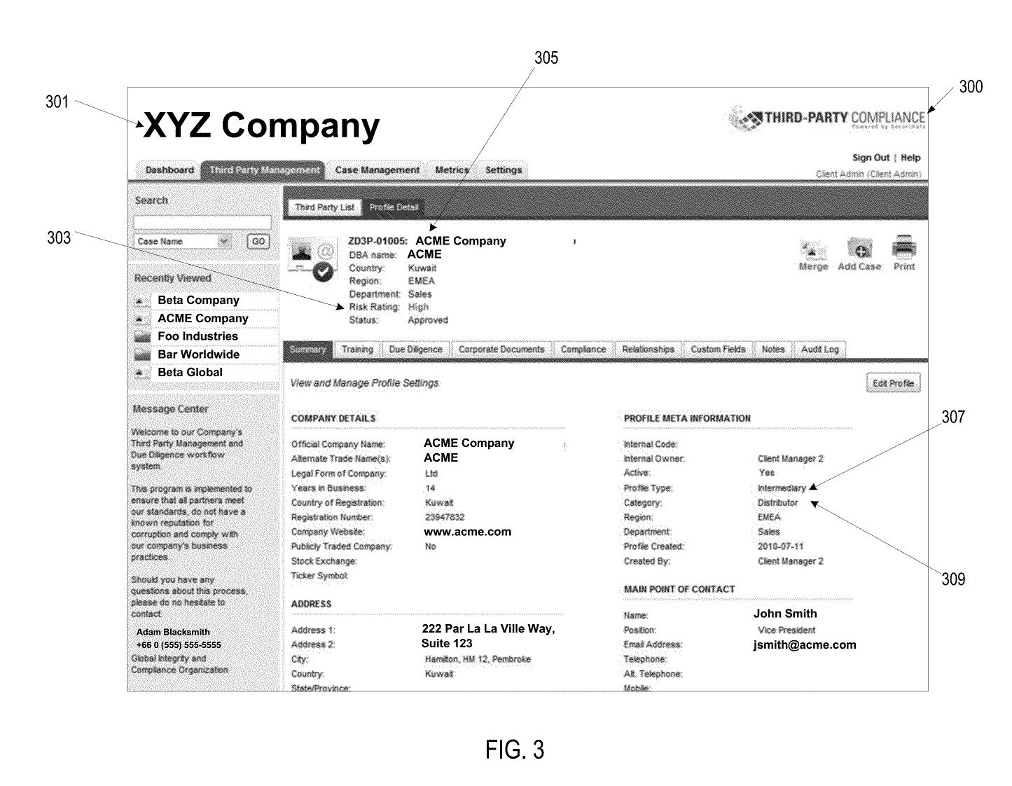

FIG. 3 is an exemplary graphical user interface (GUI) 300 for a subscriber. GUI 300 presents risk data relating to a subscriber 301 ‘XYZ Company’ that is evaluating the risk of an entity 303 ‘ACME Company’. A risk analyzer can generate GUI 300 based on the subscriber data, risk inventory data, risk tier map, risk model data, entity data, and risk results pertaining to the subscriber 301. GUI 300 includes indicators 307, 309 showing the entity type 307 ‘intermediary’ and entity sub-type 309 ‘distributor’ for entity 303. GUI 300 also includes an indicator 303 indicating the risk tier 303 of a high risk for the entity 305 ACME Company. An indicator can be an icon or some other visual indicator (e.g., text box, image, color, etc.) to indicate a risk tier.

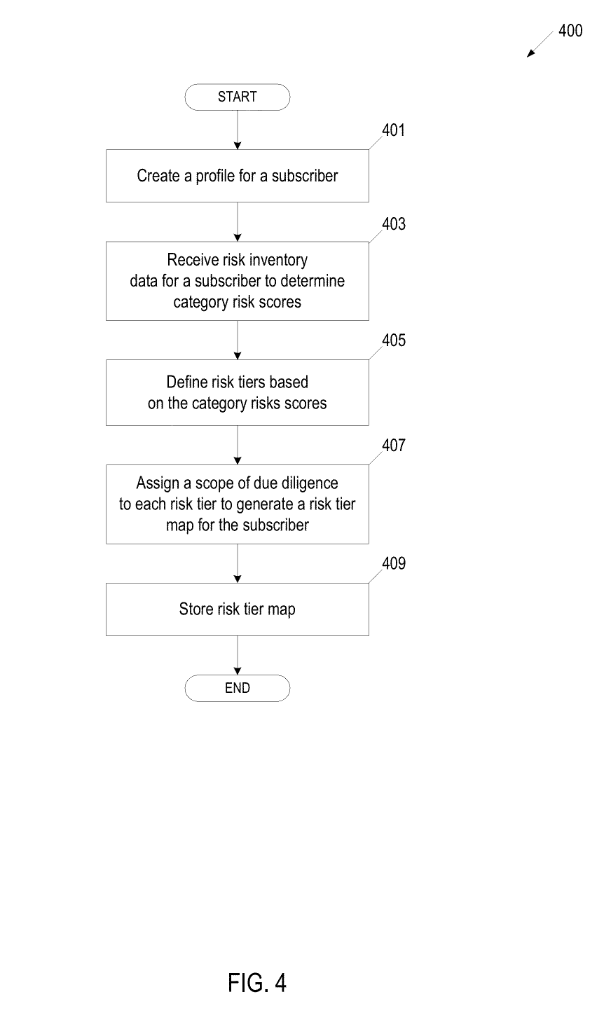

FIG. 4 is a flow diagram of an embodiment of a method 400 for generating a risk tier map. Method 400 can be performed by processing logic that can comprise hardware (e.g., circuitry, dedicated logic, programmable logic, microcode, etc.), software (e.g., instructions run on a processing device), or a combination thereof. In one embodiment, method 400 is performed by the risk analyzer 105 hosted by a server 150 of FIG. 1.

In one embodiment, the method 400 starts with the risk analyzer creating a profile for a subscriber at block 401. The risk analyzer can create a profile for more than one subscriber. A profile is created based on subscriber profile data that is received, for example, as user input via a user interface. At block 403, the risk analyzer receives risk inventory data for a subscriber to determine category risk scores. At block 405, the risk analyzer defines risk tiers based on the category risk scores and assigns a scope of due diligence to each risk tier to generate a risk tier map for the subscriber. The risk analyzer can also assign a scope of training, a scope of education, approvals required to conduct a business transaction with an entity, and/or a scope and frequency of auditing an entity to each risk tier as part of the risk tier map. The risk analyzer stores the risk tier map at block 409. Subsequently, the risk analyzer can execute a risk model to generate a risk score for an entity and compare the entity's risk score to the risk tier map to categorize the entity's risk and to provide a due diligence recommendation based on the entity's risk.

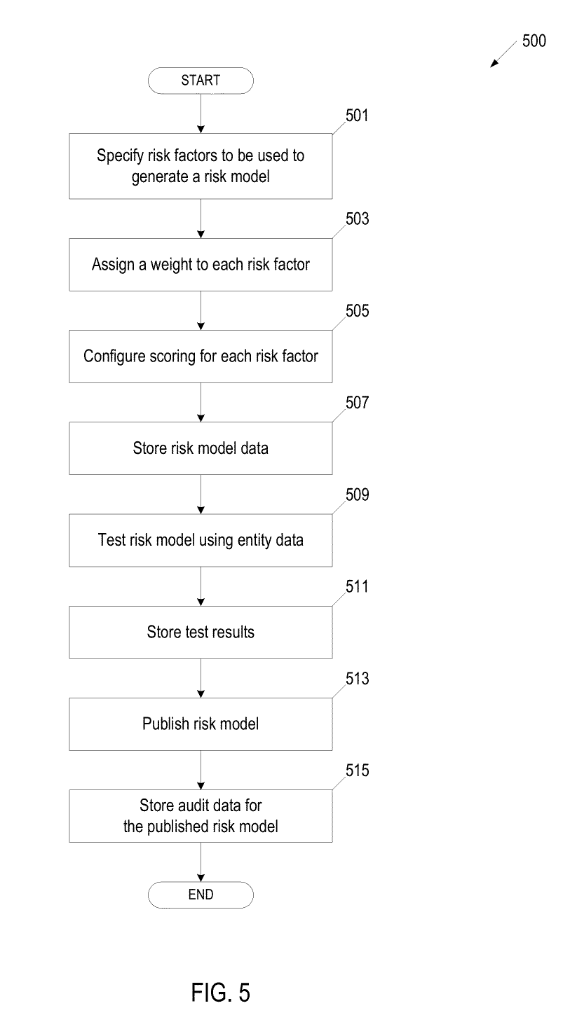

FIG. 5 is a flow diagram of an embodiment of a method 500 for generating a custom risk model for a subscriber. Method 500 can be performed by processing logic that can comprise hardware (e.g., circuitry, dedicated logic, programmable logic, microcode, etc.), software (e.g., instructions run on a processing device), or a combination thereof. In one embodiment, method 500 is performed by the risk analyzer 105 hosted by a server 150 of FIG. 1.

In one embodiment, the method 500 starts with the risk analyzer using multiple default risk factors at block 501. The default risk factors can include third party category, the Corruption Perception Index (CPI), data from a due diligence questionnaire, and data from a Business Justification Questionnaire. Examples of business justification data can include, and are not limited to the types of contracts an entity may engage with a subscriber, a volume of business that an entity may conduct with a subscriber, etc. For example, if an entity is going to conduct a large volume of business, such as greater than one hundred million dollars, the risk analyzer may use this as one factor to determine whether the entity is a high risk. Likewise, if an entity is going to conduct a small volume of business, such as less than one hundred thousand dollars, the risk analyzer may use this as one factor to determine whether the entity is a low risk. In another embodiment, the risk analyzer can specifying risk factors to be used to generate a risk model based on user input at block 501.

At block 503, the risk analyzer assigns a weight to each risk factor and configures the scoring for each risk factor at block 505. At block 507, the risk analyzer stores the configurations as a risk model in a data store that is coupled to the risk analyzer. At block 509, the risk analyzer tests the risk model and stores test results at block 511. The risk analyzer can test a risk model any number of times and can continue to adjust the configuration of the risk model, for example, based on subscriber input. When a subscriber finalizes testing a risk model, the risk analyzer can publish the risk model at block 513. A published risk model is persistently stored in the risk analyzer. For data integrity and auditing purposes, data pertaining to a published risk model cannot be removed from a risk analyzer. The risk analyzer can store auditing data (e.g., date/time a risk model is published, dates/times a published risk model is executed, etc.) pertaining to the risk model in the data store at block 515.

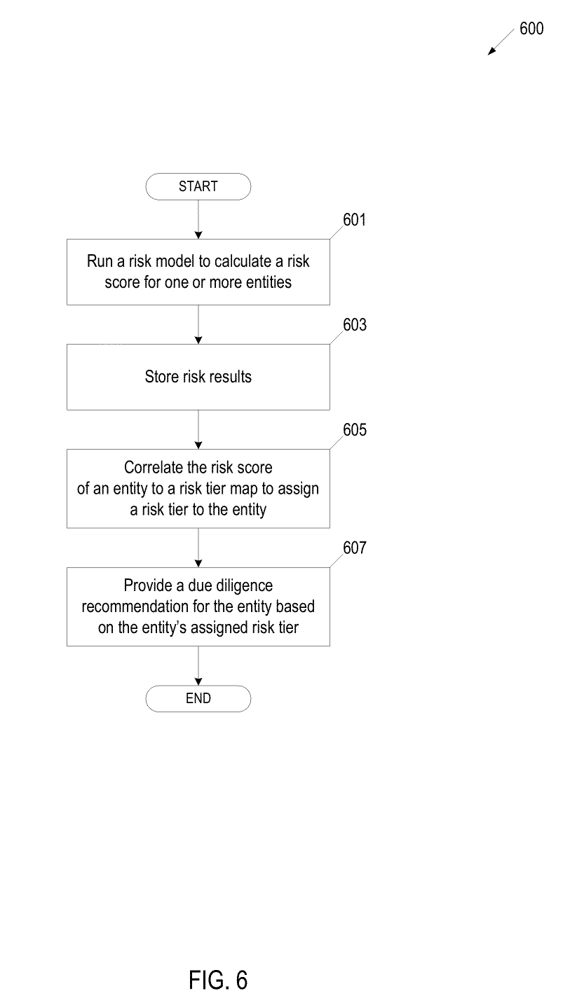

FIG. 6 is a flow diagram of an embodiment of a method 600 for analyzing risk of one or more entities. Method 600 can be performed by processing logic that can comprise hardware (e.g., circuitry, dedicated logic, programmable logic, microcode, etc.), software (e.g., instructions run on a processing device), or a combination thereof. In one embodiment, method 600 is performed by the risk analyzer 105 hosted by a server 150 of FIG. 1. In one embodiment, the method 600 starts with the risk analyzer running a risk model of a subscriber to calculate a risk score for entities at block 601 and storing the risk results in a data store at block 603.

At block 605, the risk analyzer correlates the risk score of an entity to a risk tier map of the subscriber to assign a risk tier to the entity. The risk analyzer can store the assigned risk tiers as risk results data in the data store. At block 607, the risk analyzer provides a due diligence recommendation for the entity using the risk tier map and based on the entity's assigned risk tier. The risk analyzer can store the risk recommendation in a data store that is coupled to the risk analyzer. A risk recommendation can include a recommendation that no further action needs to be performed. A risk recommendation can also include a recommended due diligence investigation to be performed on an entity, a recommended training for the entity, approvals to be obtained for a subscriber to conduct a business transaction with an entity, legal documents to be executed, audit frequencies, etc. A risk recommendation can also include a recommendation for an internal subscriber action to be performed. A service provider, such as one that provides due diligence investigation services, can conduct the recommended due diligence action. The risk analyzer can communicate with a client in a service provider environment (e.g., client 142 service provider in service provider environment 108 in FIG. 1) to cause a service to be performed based on the recommendation. The risk analyzer can also communicate with a client in a subscriber environment (e.g., client 141 service provider in service provider environment 107 in FIG. 1) to cause a subscriber to perform a service based on a risk recommendation.

The risk analyzer can provide GUIs showing the risk results. A subscriber can use the risk results to determine a budget for risk analysis. The GUIs can include data for a particular risk tier. For example, a GUI can show the countries assigned to a high risk tier and a subscriber can determine the risk costs associated for with each country.

FIG. 7 is a diagram of one embodiment of a computer system for providing a custom risk analysis service. Within the computer system 700 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client machine (e.g., a client computer executing the browser and the server computer executing the automated task delegation and project management) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes a processing device 702, a main memory 704 (e.g., read-only memory (ROM), flash memory, dynamic random access memory (DRAM) such as synchronous DRAM (SDRAM) or DRAM (RDRAM), etc.), a static memory 706 (e.g., flash memory, static random access memory (SRAM), etc.), and a secondary memory 716 (e.g., a data storage device in the form of a drive unit, which may include fixed or removable computer-readable storage medium), which communicate with each other via a bus 708.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 is configured to execute the risk analyzer 726 for performing the operations and steps discussed herein.

The computer system 700 may further include a network interface device 722. The computer system 700 also may include a video display unit 710 (e.g., a liquid crystal display (LCD) or a cathode ray tube (CRT)) connected to the computer system through a graphics port and graphics chipset, an alphanumeric input device 712 (e.g., a keyboard), a cursor control device 714 (e.g., a mouse), and a signal generation device 720 (e.g., a speaker).

The secondary memory 716 may include a machine-readable storage medium (or more specifically a computer-readable storage medium) 724 on which is stored one or more sets of instructions (e.g., the risk analyzer 726) embodying any one or more of the methodologies or functions described herein. The risk analyzer 726 may also reside, completely or at least partially, within the main memory 704 and/or within the processing device 702 during execution thereof by the computer system 700, the main memory 704 and the processing device 702 also constituting machine-readable storage media. The risk analyzer 726 may further be transmitted or received over a network 718 via the network interface device 722.

The computer-readable storage medium 724 may also be used to store the risk analyzer 726 persistently. While the computer-readable storage medium 724 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The risk analyzer 726, components and other features described herein (for example in relation to FIG. 1) can be implemented as discrete hardware components or integrated in the functionality of hardware components such as ASICS, FPGAs, DSPs or similar devices. In addition, the risk analyzer 726 can be implemented as firmware or functional circuitry within hardware devices. Further, the risk analyzer 726 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “generating,” “executing,” “determining,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus can be specially constructed for the required purposes, or it can comprise a general purpose computer system specifically programmed by a computer program stored in the computer system. Such a computer program can be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of embodiments of the invention as described herein.

A computer-readable storage medium can include any mechanism for storing information in a form readable by a machine (e.g., a computer), but is not limited to, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

Thus, a method and apparatus for providing a custom risk analysis service is described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method for generating a custom risk model by a server computing system comprising:
receiving, by a processing device of the server computer system, risk inventory data from a plurality of client devices, wherein each of the plurality of client devices is associated with a different subscriber of a plurality of subscribers of a risk analysis service;
storing, by the processing device, the risk inventory data in a memory of the server computing system;
generating, by the processing device and based on the risk inventory data a plurality of risk tier maps for the plurality of subscribers, each risk tier map mapping a plurality of risk tiers to corresponding risk score ranges, wherein generating one of the plurality of risk tier maps comprises:
parsing the risk inventory data to identify a number of risk tiers from the plurality of risk tiers, each risk tier to define a severity level of a risk; and
calculating a risk score range associated with each of the risk tiers;
receiving, by the processing device, subscriber input data from the plurality of client devices, the subscriber input data comprising a plurality of risk factors;
storing, by the processing device, the subscriber input data in the memory of the server computing system;
generating, by the processing device, the custom risk model for a first subscriber of the plurality of subscribers based on a first plurality of risk factors, wherein the first plurality of risk factors and a corresponding weighting value for each of the first plurality of risk factors are defined by the first subscriber, wherein the first plurality of risk factors are configurable based on subscriber data for the first subscriber and are based on projected business transactional data;
storing, by the processing device, the custom risk model in the memory of the server computing service for execution by a risk analysis process to determine a first risk score for a third-party entity using third party entity data, the first risk score to represent a risk to the first subscriber, the risk associated with engaging in a business relationship with the third-party entity; and
generating, by the processing device, first risk recommendation instructions for the first subscriber associated with the third-party entity, wherein generating the first risk recommendation instructions comprises correlating the first risk score with one of the plurality of tiers in a risk tier map from the plurality of risk tier maps that corresponds to the first subscriber, the first risk recommendation instructions corresponding to the severity level of the risk to the first subscriber and comprising a scope of a due diligence investigation to be performed with respect to the third-party entity.

2. The method of claim 1, further comprising:
providing the risk analysis service to the plurality of subscribers as software as a service (SaaS) via a network; and
storing subscriber profile data for the plurality of subscribers in a data store.

3. (canceled)

4. The method of claim 1, wherein the first risk recommendation further comprises at least one of training for the corresponding entity, approvals to be obtained for a corresponding subscriber to conduct business transactions with the corresponding entity, legal documents to be executed, audit frequencies, no action to be performed, or an internal subscriber action to be performed.

5. The method of claim 1, wherein the first plurality of risk factors comprises at least one of a third party category, an annual index, data from a questionnaire, or a subscriber defined risk factor.

6. The method of claim 1, wherein the plurality of risk tier maps comprises:
a plurality of risk score ranges for the plurality of risk tiers and a plurality of scopes of action for the plurality of risk tiers.

7. The method of claim 1, further comprising:
assigning a weight to one of the first plurality of risk factors based on user input received from the first subscriber.

8. The method of claim 1, further comprising:
configuring a score of one of the first plurality of risk factors based on user input received from the first subscriber.

9. The method of claim 1, further comprising:
testing the first custom risk model; and
publishing the first custom risk model.

10. A system comprising:
a memory; and
a processor coupled to the memory to:
receive risk inventory data from a plurality of client devices, wherein each of the plurality of client devices is associated with a different subscriber of a plurality of subscribers of a risk analysis service;
store the risk inventory data in the memory;
generate a plurality of risk tier maps for the plurality of subscribers, each risk tier map mapping a plurality of risk tiers to corresponding risk score ranges, wherein to generate one of the plurality of risk tier maps, the processor to:
parse the risk inventory data to identify a number of risk tiers from the plurality of risk tiers, each risk tier to define a severity level of a risk; and
calculate a risk score range associated with each of the risk tiers;
receive subscriber input data from the plurality of client devices, the subscriber input data comprising a plurality of risk factors;
store the subscriber input data in the memory;
generate a custom risk model for a first subscriber of the plurality of subscribers based on a first plurality of risk factors, wherein the first plurality of risk factors and a corresponding weighting value for each of the first plurality of risk factors are defined by the first subscriber, wherein the first plurality of risk factors are configurable based on subscriber data for the first subscriber and are based on projected business transactional data,
store the custom risk model in the memory for execution by a risk analysis process to determine a first risk score for a third-party entity using third party entity data, the first risk score to represent a risk to the first subscriber, the risk associated with engaging in a business relationship with the third-party entity,
generate first risk recommendation instructions for the first subscriber associated with the third-party entity, wherein generating the first risk recommendation instructions comprises correlating the first risk score with one of the plurality of tiers in a risk tier map from the plurality of risk tier maps that corresponds to the first subscriber, the first risk recommendation instructions corresponding to the severity level of the risk to the first subscriber and comprising a scope of a due diligence investigation to be performed with respect to the third-party entity.

11. The system of claim 10, wherein the processor is further to:
provide the risk analysis service to the plurality of subscribers as software as a service (SaaS) via a network.

12. (canceled)

13. The system of claim 10, wherein the first risk recommendation comprises at least one of training for the corresponding entity, approvals to be obtained for a corresponding subscriber to conduct business transactions with the corresponding entity, audit frequencies, no action to be performed, or an internal subscriber actions to be performed.

14. The system of claim 10, wherein the first plurality of risk factors comprises at least one of a third party category, an annual index, data from a questionnaire, or a subscriber defined risk factor.

15. The system of claim 10, wherein the plurality of risk tier maps comprises a plurality of risk score ranges for the plurality of risk tiers and a plurality of scopes of action for the plurality of risk tiers.

16. The system of claim 10, wherein the processor is further to:
assign a weight to one of the first plurality of risk factors based on user input received from the first subscriber; and
configure a score of one of the first plurality of risk factors based on user input received from the first subscriber.

17. The system of claim 10, wherein the system further comprises:
a data store to store subscriber profile data for the plurality of subscribers.

18. The system of claim 10, wherein the processor is further to:
test the first custom risk model; and
publish the first custom risk model.

19. A non-transitory computer-readable storage medium including instructions that, when executed by a processing device, cause the processing device to perform a set of operations comprising:
receiving, by the processing device, risk inventory data from a plurality of client devices, wherein each of the plurality of client devices is associated with a different subscriber of a plurality of subscribers of a risk analysis service;
storing, by the processing device, the risk inventory data in a memory of the server computing system;
generating, by the processing device and based on the risk inventory data-a plurality of risk tier maps for the plurality of subscribers, each risk tier map mapping a plurality of risk tiers to corresponding risk score ranges, wherein generating one of the plurality of risk tier maps comprises:
parsing the risk inventory data to identify a number of risk tiers from the plurality of risk tiers, each risk tier to define a severity level of a risk; and
calculating a risk score range associated with each of the risk tiers;
receiving, by the processing device, subscriber input data from the plurality of client devices, the subscriber input data comprising a plurality of risk factors;
storing, by the processing device, the subscriber input data in the memory of the server computing system;
generating, by the processing device, a custom risk model for a first subscriber of the plurality of subscribers based on a first plurality of risk factors, wherein the first plurality of risk factors and a corresponding weighting value for each of the first plurality of risk factors are defined by the first subscriber, wherein the first plurality of risk factors are configurable based on subscriber data for the first subscriber and are based on projected business transactional data;
storing, by the processing device, the custom risk model in the memory of the server computing service for execution by a risk analysis process to determine a first risk score for a third-party entity using third party entity data, the first risk score to represent a risk to the first subscriber, the risk associated with engaging in a business relationship with the third-party entity; and
generating, by the processing device, first risk recommendation instructions for the first subscriber associated with the third-party entity, wherein generating the first risk recommendation instructions comprises correlating the first risk score with one of the plurality of tiers in a risk tier map from the plurality of risk tier maps that corresponds to the first subscriber, the first risk recommendation instructions corresponding to the severity level of the risk to the first subscriber and comprising a scope of a due diligence investigation to be performed with respect to the third-party entity.

20. The non-transitory computer-readable storage medium of claim 19, the operations further comprising:
providing the risk analysis service to the plurality of subscribers as software as a service (SaaS) via a network; and
storing subscriber profile data for the plurality of subscribers in a data store.

21. (canceled)

22. The non-transitory computer-readable storage medium of claim 19, wherein the first risk recommendation comprises at least one of training for the corresponding entity, approvals to be obtained for a corresponding subscriber to conduct business transactions with the corresponding entity, audit frequencies, no action to be performed, or an internal subscriber action to be performed.

23. The non-transitory computer-readable storage medium of claim 19, wherein the first plurality of risk factors comprises at least one of a third party category, an annual index, data from a questionnaire, or a subscriber defined risk factor.

24. The non-transitory computer-readable storage medium of claim 19, wherein the plurality of risk tier maps comprises a plurality of risk score ranges for the plurality of risk tiers and a plurality of scopes of action for the plurality of risk tiers.

25. The non-transitory computer-readable storage medium of claim 19, the operations further comprising:
assigning a weight to one of the first plurality of risk factors based on user input received from the first subscriber.

26. The non-transitory computer-readable storage medium of claim 19, the operations further comprising:
testing the first custom risk model; and
publishing the first custom risk model.

27. The method of claim 1, wherein one of the first plurality of risk factors comprises an annual volume of business projected for the third-party entity.

28. The system of claim 10, wherein one of the first plurality of risk factors comprises an annual volume of business projected for the third-party entity.

29. The non-transitory computer-readable storage medium of claim 19, wherein one of the first plurality of risk factors comprises an annual volume of business projected for the third-party entity.
